(19) United States
(12) Patent Application Publication
(10) Pub. No.: US 2025/0173383 A1
(43) Pub. Date: May 29, 2025

(54) System and Method for Processing Large Datasets Including Filtering and Model Training After Filtering, with a Specified Order of Operations

(71) Applicant: RecruitBot Inc., San Francisco, CA (US)

(72) Inventors: Jeremy Ryan Schiff, San Francisco, CA (US); Steven Erik Simunic, Emeryville, CA (US); Brandon Hay, New York, NY (US)

(21) Appl. No.: 19/038,269

(22) Filed: Jan. 27, 2025

Related U.S. Application Data
(63) Continuation-in-part of application No. 15/902,389, filed on Feb. 22, 2018.

(51) Int. Cl. G06F 16/9535; G06F 16/951; G06Q 10/1053

(52) U.S. Cl. CPC G06F 16/9535; G06F 16/951; G06Q 10/1053

(57) ABSTRACT

A computer-implemented method might comprise obtaining filter criteria, applying the filter criteria to data about persons in a data repository to obtain filtered search results, training a model from the data from the data repository, storing the model in a machine learning models database, executing the model with a machine learning system having the search results as an input to the machine learning system, processing the search results, after applying the filter criteria to the job candidate data, using the machine learning system to rank at least a portion of the search results into a ranked subset of the search results, applying supervised training to the model based on example records from the least a portion of the filtered search results, revising the model based on the supervised training to form a revised model, and producing scores for records of the filtered search results based on the revised model.

### CROSS-REFERENCES TO PRIORITY AND RELATED APPLICATIONS

This application is a continuation-in-part of U.S. patent application Ser. No. 15/902,389, filed Feb. 22, 2018, (Attorney Docket No. 70737.2US01) entitled “System and Method for Sourcing, Ranking and Filtering Job Candidates”. The entire disclosure of the application recited above is hereby incorporated by reference, as if set forth in full in this document, for all purposes.

### FIELD

The present disclosure relates generally data processing including filtering, training a model, and executing the model, and more particularly, to data processing with an order of operations to improve a trained search of a large body of data.

### BACKGROUND

Some bodies of data are large enough that effectively searching for relevant data can be a computationally expensive problem. One such body of data is data about job candidates. Such data might comprise millions of candidates and/or potential candidates. Other bodies of data might also benefit from improved search processes.

It can be a problem for people and organizations to cull a list of candidates to speed up the selection of viable candidates for a specific job position. Previous approaches typically involve 1) searching and filtering for relevant keywords much like is done in general web search and 2) filtering structured data, for instance by company name or title. These systems suffer from a number of limitations because they do not capture implicit data, such as click history, or explicit data, such as rating data, about specific users' preferences to tailor the information to the company's specific needs for a specific position. Because the set of potential candidates is evolving constantly, a significant amount of repeated work occurs every time potential candidates are evaluated to determine if they are the proper fit for the organization, and for which positions.

In addition, when multiple people are involved in the vetting of candidates, there is no way to provide visibility into the consistency or disagreement regarding evaluation. Therefore, there is a need to collect implicit and explicit feedback about candidates to help organizations better understand and resolve disagreements, more quickly move forward with candidates where there is clear consensus, or allow candidates rejected by some members of the organization to be down-ranked or filtered from the results of others. There is also a need to determine common properties, explicit and derived, involved in decision making to help refine the hiring process, reduce bias in decision-making, and facilitate conversation about what's important based on action, as opposed to people's opinions.

There are significant pain points involved in sourcing relevant candidates for a position. There is a need for a system that can be coupled with many different sourcing strategies designed to address these pain points, such as mining an Applicant Tracking System or crawling job boards and social networks for candidates.

### SUMMARY

A computer-implemented method might comprise obtaining filter criteria, applying the filter criteria to data about persons in a data repository to obtain filtered search results, training a model from the data from the data repository, storing the model in a machine learning models database, executing the model with a machine learning system having the search results as an input to the machine learning system, processing the search results, after applying the filter criteria to the job candidate data, using the machine learning system to rank at least a portion of the search results into a ranked subset of the search results, applying supervised training to the model based on example records from the least a portion of the filtered search results, revising the model based on the supervised training to form a revised model, and producing scores for records of the filtered search results based on the revised model.

In some embodiments, the persons are job candidates or potential job candidates, the data repository is a candidate data repository, the filtered search results are filtered job candidate search results, the filtered job candidate search results are the input to the machine learning system, the filter criteria is applied to the job candidate data, ranking ranks at least a portion of the filtered job candidate search results into a ranked subset of the filtered job candidate search results, the supervised training is based on example job candidate records from the least a portion of the filtered job candidate search results, and producing scores comprises producing scores for job candidates of the filtered job candidate search results based on the revised model.

A computer-implemented method might include collecting hyper-parameters specifying values to minimize a machine learning error metric or maximize a machine learning accuracy metric. Machine learning models can be revised based upon the hyper-parameters to form current machine learning models. Job candidate data can be processed with the current machine learning models to produce scores for job candidates. The scores for the job candidates can be supplied.

This Summary is provided to introduce a selection of concepts in a simplified form that are further described below in the Detailed Description. This Summary is not intended to identify key features or essential features of the claimed subject matter, nor is it intended to limit the scope of the claimed subject matter. A more extensive presentation of features, details, utilities, and advantages of methods and apparatus, as defined in the claims, is provided in the following written description of various embodiments of the disclosure and illustrated in the accompanying drawings.

### BRIEF DESCRIPTION OF THE DRAWINGS

Various embodiments in accordance with the present disclosure will be described with reference to the drawings, in which:

FIG. 1 illustrates a system configured in accordance with an embodiment of the invention.

FIG. 2 illustrates modules associated with a candidate ranking module configured in accordance with an embodiment of the invention.

FIG. 3 illustrates processing operations performed by a candidate ranking module configured in accordance with an embodiment of the invention.

FIG. 4 illustrates model processing performed in accordance with an embodiment of the invention.

FIG. 5 illustrates components associated with a host system and an applicant tracking system.

FIG. 6 illustrates processing operations associated with the system of FIG. 5.

FIG. 7 illustrates components associated with an intra-company sourcing system coupled with a candidate filtering and ranking system.

FIG. 8 illustrates processing operations associated with the system of FIG. 7.

### DETAILED DESCRIPTION

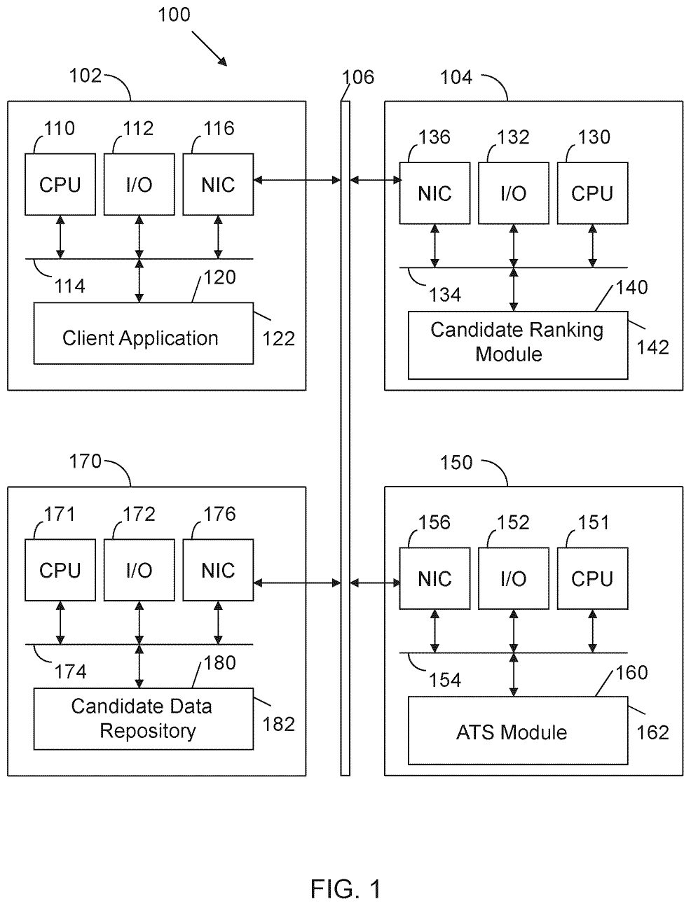

FIG. 1 illustrates a system 100 configured in accordance with an embodiment of the invention. The system 100 includes a client device 102 coupled to a server or host system 104 via a network 106, which may be any combination of wired and wireless networks. The client device 102 includes a central processing unit 110 and input/output devices 112 connected via a bus 114. The input/output devices 112 may include a keyboard, mouse, touch display and the like. A network interface circuit 116 provides connectivity to network 106. A memory 120 is also connected to the bus 114. The memory 120 stores a client application 122, which may be a dedicated application or simply a browser to access server 104.

Server 104 includes a central processing unit, input/output devices 132, a bus 134 and a network interface circuit 136. A memory 140 is also connected to the bus 134. The memory 140 stores a candidate ranking module 142, which includes instructions executed by processor 130 to implement operations disclosed herein. The candidate ranking module 142 is configured to source, rank, and filter job candidates. As discussed below, the candidate ranking module 142 utilizes network 106 to access additional networked resources, such as an applicant tracking system server 150 and a candidate data repository server 170. Processed data may then be supplied to the client device 102.

Applicant tracking system server 150 includes a central processing unit 151, input/output devices 152, a bus 154 and a network interface circuit 156. A memory 160 is connected to bus 154. The memory stores an applicant tracking system module 162. Such modules are known in the art. It is the combination and interactions between the candidate ranking module 142 and the applicant tracking system module 162 that is noteworthy.

Candidate data repository server 170 includes a central processing unit 171, input/output devices 172, a bus 174 and a network interface circuit 176. A memory 180 is connected to bus 174. The memory 180 stores a candidate data repository 182. The candidate data repository may include implicit and explicit measures of job candidates, as discussed below.

Overall, FIG. 1 illustrates a schematic of an example computer and processing system that may implement a machine learning system that predicts and ranks the relevancy of candidates for a position in one embodiment of the present disclosure. The computer system is only one example of a suitable processing system and is not intended to suggest any limitations as to the scope of use or functionality of embodiments of the methodology described herein. The processing system shown may be operated with numerous other general purpose or special purpose computing system environments or configurations. Examples of well-known computing system, environments, and/or configurations that may be suitable for use with the processing system shown in FIG. 1 may include, but are not limited to, personal computer systems, server computer systems, thin clients, thick clients, handheld, mobile, or laptop devices, multiprocessor systems, microprocessor-based systems, set top boxes, programmable consumer electronics, network PCs, minicomputer systems, mainframe computer systems, quantum computing systems, and distributed cloud computing environments that include any of the above systems or devices, and the like.

The computer system may be described in the general context of computer system executable instructions such program modules, being executed by a computer system, or in higher-level abstractions such as micro-services. Generally, program modules may include routines, programs, objects, components, logic, data structures, and so on that perform particular tasks or implement particular abstract data types. The computer system may be practiced in the distributed cloud computing environments where tasks are performed by remote processing devices that are linked through a communication network. In a distributed cloud-computing environment, program modules may be located in both local and remote computer storage media including memory storage devices.

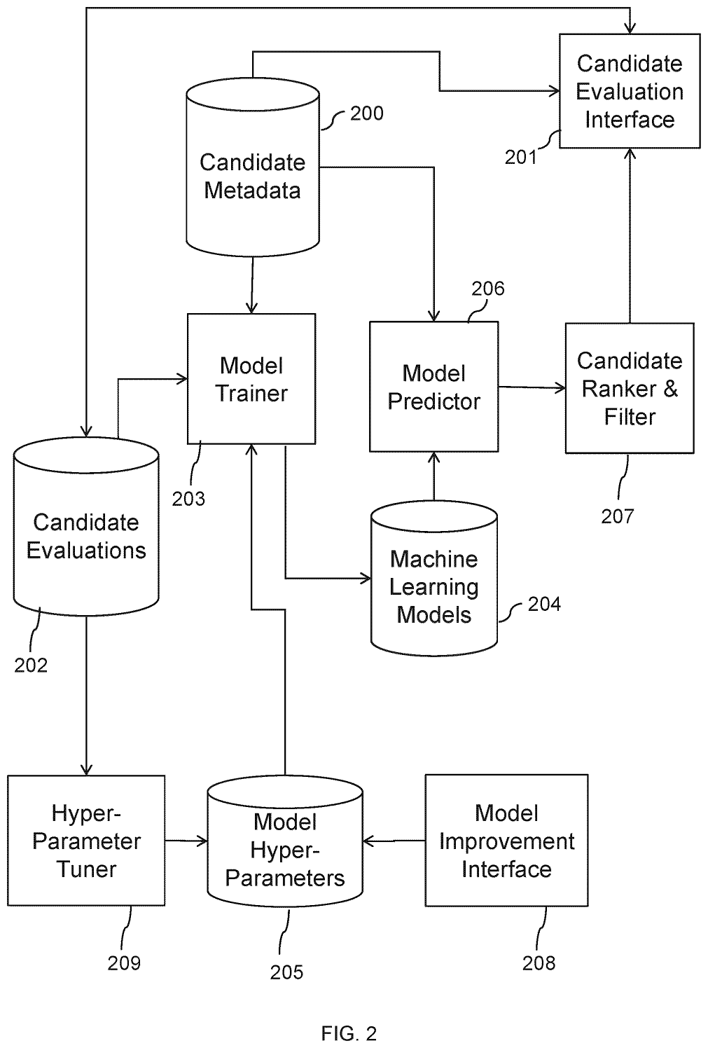

FIG. 2 is a diagram illustrating system components for a machine learning system for ranking and filtering candidates. The components shown in FIG. 2 are computer executable components, for example, of candidate ranking module 142. One or more of the hardware processors may be coupled to a memory device and or persistent storage device. A company's candidate database 200 stores all information about candidates in the system It can store simple information like resumes, or more complicated information such as structured data about the candidate, referral information, relationships to other candidates using social networks, etc.

Each user at the company uses the Candidate Evaluation Interface 201 to provide information about preferences about candidates. These evaluations may take many different forms including rating from simple yes/no to 5-star scales, to a real-valued score. The evaluations are then stored in the candidate evaluation database 202. These evaluations may also include implicit or explicit signals not directly collected from the system users. Examples of explicit signals include information like whether the user was hired to the company, users associated with this user on social networks, statistics about their code from services such as GitHub®, BitBucket®, etc. Examples of implicit signals include click data, or hiring data, or metadata stored about the candidate for other purposes. Examples of explicit signals include ratings data, lists of keywords for up-weighting or down-weighting, samples of “ideal” candidates, etc. There are many different orderings the candidate evaluation interface could use when suggesting candidates. In one embodiment, candidates are ordered based on the highest prediction of fitness for a specific position. Other criteria, such as candidates that would be the most informative for improving recommendations, using models such as maximum entropy, may also be used. Thus, one criterion or another need not be used; rather, complex functions involving multiple objectives may be used.

A model trainer 203 takes as input candidate metadata from 200, and customer evaluation data from 202 and uses this to generate or “train” a model, which it in turn stores in the Machine Learning Models Database 204. Examples of such models include rigorous prediction formulations such as supervised learning or collaborative filtering from rating data, unsupervised learning from example good and bad candidates, or may be some simpler mechanism like a set of keywords or phrases to up-weight and down-weight. It is important to highlight that generating scores or rankings for each position may use data from other positions as well, and determining the relevant positions could be automated, or be guided by user feedback for instance by selecting positions with a relevant name from a list. These models may include information about what features are extracted about the candidates, as well as parameters for the specific machine learning prediction algorithms, including hyper-parameters stored in the Model Hyper-Parameters database 205.

As used herein, a hyper-parameter is a value that is set before the learning process begins. Example hyper-parameters include the number of clusters for unsupervised learning and a regularization parameter for supervised learning. By contrast, the values of other parameters are derived via training. Hyper-parameter training involves splitting data into a training-set and a test set, whereby the machine learning is only exposed to data in the training set, but its performance is evaluated on the test-set. The hyper-parameter training searches through this space to find the hyper-parameters that minimize an error metric or maximize an accuracy metric on the test set.

Examples of machine learning models 204 may include both classification and prediction algorithms such as logistic regression, SVMs, Bayesian approaches, Deep Learning, Restricted Boltzmann Machines, Collaborative Filtering, etc. It's important to note that the methods described may not rely on a single type of machine learning method, and could be a hybrid. They could use hierarchical models or cascades of different types. For example, we could build a predictor for the company, and then depending on the amount of data about a specific position, bias away from that predictor to a predictor that is position-specific. We could also perform a similar biasing-based approach using related positions, which could be computed using methods such as intersection over union of keywords, or clustering methods such as K-means. If the predictions are over datasets that are non-binary, they may also employ methods that convert from binary classification to regression/n-class classification including methods such as one-versus-one and one-versus-many. The machine learning models generated by the Model Trainer 203 and stored in the Machine Learning Models database 204 are used with the candidate metadata of candidate database 200 to predict a score of relevancy for a position or relative ranking between the candidates. The Model Predictor 206 is responsible for using the candidate metadata and model to generate a set of scores or rankings. Through the candidate evaluation interface, or system specific defaults and auto-tuning algorithms, specific criteria for ranking and filtering can be specified to show all or a subset of the ranked candidates. The Candidate Evaluation Interface 201 may communicate this information to the Candidate Ranker and Filter component 207, which in turn will take the output from the Model Predictor 204 and re-rank or filter it accordingly. The Candidate Ranker and Filter component 207 can be used to order the candidates from good to bad based on a predicted score of relevancy, for instance using supervised learning, or to hide candidates that have a score below a specified threshold. This threshold could be computed automatically, or set by a user, or some hybrid of the two. It. could also be toggled dynamically as the user explores the candidates. Ultimately this data is sent to a frontend such as a web page, application, or mobile device via the Candidate Evaluation Interface 201 for the user to observe the predicted scores or rankings, such as at client device 102.

The Candidate Evaluation Interface 201 can serve many different purposes by changing the ranking criteria or data it seeks to collect. It can surface predictions and ranking for the purposes of a user determining whom it is best to reach out to for an interview, to hire, etc. It can also surface predictions and ranking for the purposes of a user providing data most useful to the task at hand, such as improving the predictions themselves. The Candidate Evaluation Interface 201 can also present information to modify the models. For example, we could use a Model Improvement Interface 208, which may or may not work in tandem with the Candidate Evaluation Interface 201, to surface words that are correlated or anti-correlated with good candidates, and allow users to select the terms or phrases they think are the most useful, and we could interpret this information as parameters we would store it as information in the Model Hyper-Parameters Database 205 to provide additional inputs to the Model Trainer 203, and when determining the information's utility by the Hyper-Parameter Tuner 209. For instance, we train a model but restrict the features to only be words selected by users, rather than the entire corpus of words. If we use a supervised learning framework, the Hyper-Parameter Tuner 209 could use approaches, such as simple grid-search, to more sophisticated parameter estimation methods, to modify how the model does learning and store those hyperparameters in the Model Hyper-Parameter Database 205. The hyper-parameter database could also maintain statistics about the accuracy for different models, which could be modeled with many different metrics including simple right/wrong counts, minimizing a function of false positives and negatives, root mean square error, etc.

There are a number of more specific instantiations of this. One such system is a supervised machine learning system that performs learning based on either a binary classification, for instance rating a good candidate or bad candidate. Another supervised system uses regression, for instance based on a 5 star-scale, click-through data, or hiring data. Yet another system takes in a set of “good” and “bad” examples and uses unsupervised learning to score the other candidates. These systems predict the best-fit candidates per the learned models, and the candidates are ranked accordingly. Additional mechanisms may be used to filter the results, more in line with conventional search engines, or augment the ranking beyond directly using the score.

An embodiment of the system allows a user to improve the models by providing domain-specific information via the Model Improvement Interface 208. For instance, the interface 208 could present the user a set of keywords and key-phrases that are highly correlated with positive candidates, or highly anti-correlated with negative candidates. These keywords are normalized, for instance using term frequency-inverse document frequency (TF-IDF) techniques. The users then selects terms and phrases most relevant to their domain to aid in the accuracy of the machine learning models when doing hyper-parameter tuning 209 or model training 203. The system provides feedback, possibly real-time feedback, about the ramification of these decisions on the model performance in the Model Improvement Interface 208. This allows users of the system to have a way of controlling how the system works, but still allows the machine learning to tune the system to discriminate results using these keywords. The users may select weights, either positive or negative, for the selected words, rather than deferring to a computer system

Another extension of the system allows users to specify domain-specific synonyms, which could both be used to improve predictions for a specific position, and to improve predictions for other similar predictions. For example, if we understand that “Berkeley” is the same as “Stanford” for a “Software Engineering Hire” domain, we could model this association, for instance merging them in the feature space, before passing the feature vectors to a Machine Learning algorithm. A merged feature space may be based upon positions that share the same names. This allows for more sophisticated user interfaces, where use synonyms from other positions, or even “types” of positions like software engineer can be equated.

Embodiments predict that the synonyms are transferrable from one position to another. Information about similar positions provide an additional type of training data. Another extension of this system allows users to specify another position, which may or may not be part of the company's set of trained examples, to pre-seed this position's predictions, thereby bypassing the need of a set of evaluations for bootstrapping. As the user rates more positions, the model is biased away from the generic model, and towards the specific ratings for the position.

Another extension of this system includes using the Candidate Evaluations from 202 across multiple users evaluating the candidates for a specific position, and in turn when training models 203. A report shows the ratings of different evaluators for the same candidate. A report specifies the most consistently rated and least consistently rated candidates. One use of such information is to spur discussion about the inconsistency to get evaluators on the same page. Ranking functions may be used to fuse ratings across multiple people, for example minimum regret, setting the score to be the minimum of all of the evaluations. This would mean if one evaluator ranked a candidate poorly, other members would never have to review the candidate's work. Other such functions could weight a manager's vote much more highly than an individual contributor. A model may be trained to predict how a group would vote given a subset of ratings from those individuals.

An embodiment of the system contemplates standardizing the content presented about candidates in a way to reduce bias based on the layout, order of content, or other demographic information about a user. For example, the system could parse the resume, and then generate a new resume where the sections are always in the order, Summary, Education, Work History, etc. Another example is stripping out personalized information about a candidate, such as a name that a user may use to infer gender, as a mechanism to reduce gender bias in candidate evaluation. In some embodiments, resumes could be parsed into synthetic resumes, possibly amended as described herein, and then used as regular resumes.

An embodiment of the system contemplates determining which candidates have the most disagreement about them. For example, the system could identify the greatest absolute difference between the highest and lowest star rating, if using a 5-star rating scheme to evaluate. In another example, the system identifies user ratings that are most different than predicted ratings.

An embodiment of the system contemplates comparing how different teams or companies make decisions about similar positions. One such extension contemplates allowing a user to select a “generic” model that is trained on a set of similar positions, and then is further personalized to a role at a specific company. Another extension uses the information to display differences in base statistics like candidates reviewed per week, or conversion percentages at different stages of the hiring funnel, for instance from candidates accepted at the resume-review stage to candidates hired. This helps when identifying which part of a team or organization is doing particularly well or poorly.

Another embodiment removes demographic information relating to bias for candidates. For example, specific keywords in resumes that are biased toward certain demographics are learned. These keywords are used to either obscure or modify the resume information, or modify the voting system to normalize for these biases. Implicit and explicit signals may be used to determine which keywords are problematic. For instance, one can predict how a candidate will perform, and then predict how the same candidate with a changed name will perform If the resume performs better, we would want to obscure the name, and could prove it was actually biasing results unfairly.

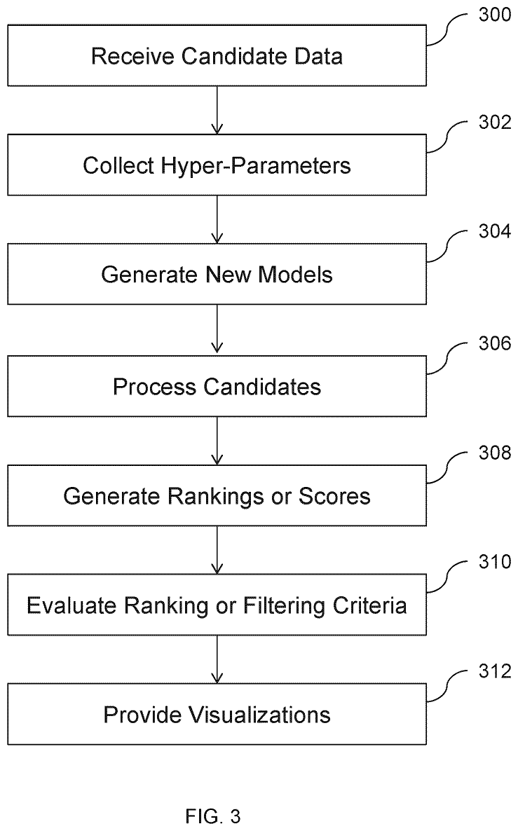

FIG. 3 is a flow diagram illustrating system components for a machine learning system for learning to predict and rank the relevancy of candidates in one embodiment of the present disclosure. At 300, the system receives candidate data. The candidate data may include candidate evaluations, explicit candidate information (e.g., prior employment history, salary history, etc.) and implicit candidate information (e.g., social media data, industry compensation range for the specified position, etc.) At 302, Hyper-Parameters from the last tuning are collected, and are used to generate new models 304. These models could be generated on many different kinds of events, such as every time new evaluations arrive, based on specific external conditions, or on a simple timer.

At 306, the candidates are processed, possibly generating the statistics about any new candidates that have come in, possibly caching these statistics, and cross-referencing them with the candidate evaluations to generate new models. At 308, the new models are used to generate the candidate scores, which implicitly define a ranking, or direct rankings are generated.

At 310, the rankings are re-ranked or filtered, which in turn are visualized at 312 by a user. These “visualizations” may also include non-user-specific events such as a candidate arriving with a high-quality score, which in turn would generate an email highlighting to the user that the candidate has arrived that must have action taken on immediately. In some embodiments, data is ingested and submitted to job boards and feedback is provided to the job boards about quality of proposed candidate-position pairings.

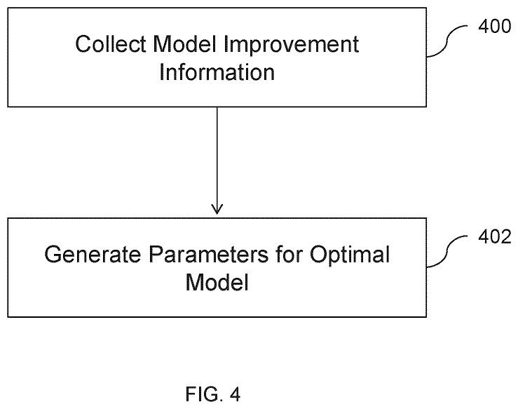

FIG. 4 is a flow diagram illustrating a method for applying hyper-parameter tuning to optimize the models of a machine learning system for learning to predict and rank the relevancy of candidates, possibly also taking as input additional domain-specific information from the user. At 400, the system collects model improvement information from the user, such as concepts that can be treated as synonyms. At 402, the system generates parameters for an optimal model, evaluating if the synonyms are harmful, or are at least not significantly harmful to the system Significant harm would be defined as some metric of exceeding acceptable error from optimal without using such synonyms.

Once the basic ranking and filtering system is in place, it can be augmented with many different ways of performing automated sourcing, finding candidates that are potentially relevant to the position, rather than relying on a human finding resumes and uploading them to the system.

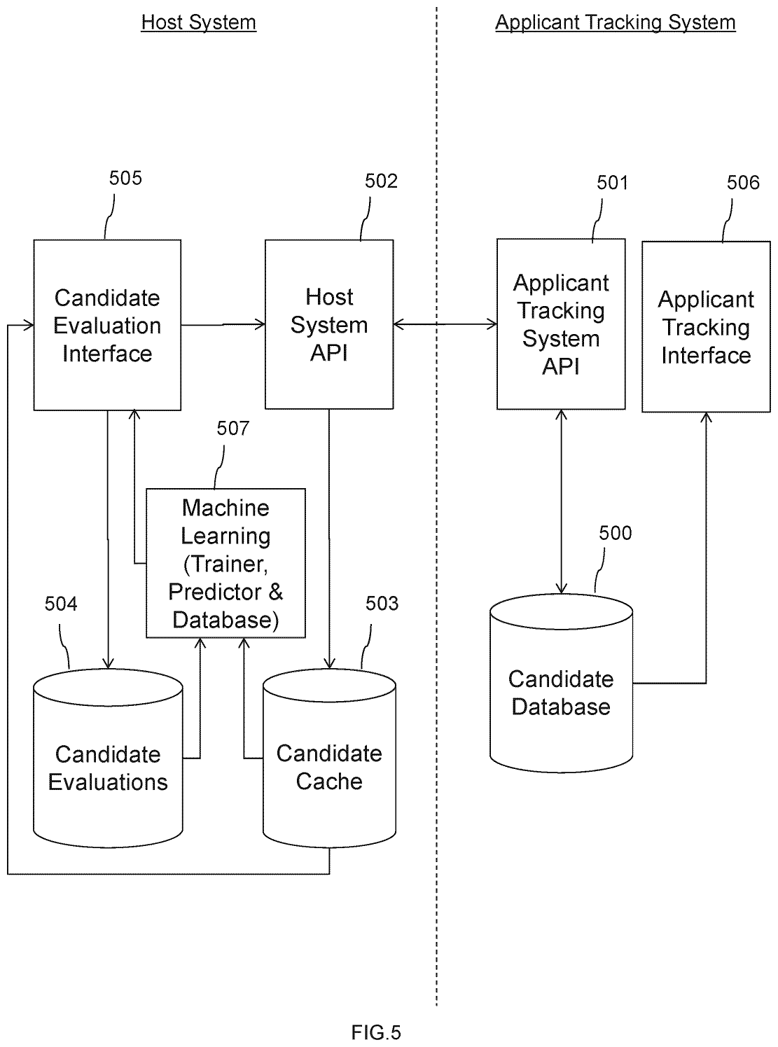

One such route is to specifically integrate with Applicant Tracking Systems, or “ATSs”. ATSs are typically the systems in which the candidate resumes reside, and the status of where each candidate is in the recruiting pipeline is tracked. The candidate ranking module 142 integrates with the Applicant Tracking System module 162 to automatically ingest over network 106 different resumes and candidate metadata. FIG. 5 is a diagram illustrating system components for a machine learning system for the integration of a candidate filter and ranking system with an Applicant Tracking system in one embodiment of the present disclosure. The candidate resumes and metadata are stored in an ATS Candidate Database 500.

That data is accessed and intermittently synchronized, whether by polling, or some event like a new candidate arriving in the ATS between the ATS API 501, and the Host System API 502 which is the software that coordinates the data ingestion. The relevant resume and other candidate metadata may be cached in a separate database 503 for faster and more flexible access. The candidate data in the cache is provided to the Candidate Evaluation Interface 504 for users to interact with an optimized queue of potential candidates, as described in the initial ranking and filtering system Similarly in the first system, the evaluations are stored in a Candidate Evaluation database 504, corresponding to candidate evaluation database 202 of FIG. 2. These judgments can be rating data, or textual data, but can be other kinds of data, like which users should move from the initial resume screening to rejection, or the next step in the interview process. This information can be pushed back into the ATS, for instance the candidate stage could be updated based on the interaction, both explicitly based on a user request, or implicitly, for instance by a user rating a low score indicating an automatic rejection. This can also be pushed into the ATS from the host system API 502 via the ATS API 501 in a way that directly changes the data and has implied side effects, such as rejecting a candidate and automatically sending a reject email, or a way that simply records data that is easy for a user to interact with, but without having side effects. For instance, an embodiment encodes that a candidate should be rejected as a tag for the candidate. The user could then use the ATS Interface 506 to either interact with this data in a one-off way, or in bulk, for example rejecting all candidates who were marked as rejected in the Candidate Evaluation Interface 505. Interacting with the ATS API 501 in turn stores this information in the ATS Candidate Database 500 and is interacted with using the pre-existing workflows provided by the ATS interface 506. Similarly to the system of FIG. 2, model training 203, 204, hyper-parameter tuning 205, 208, 209 and prediction and ranking/filtering pipelines 206, 207 are all be incorporated into this system (represented as the Machine Learning System 507).

The sourcing for candidates can take many different forms. One example is optimizing the candidates already assigned to that position, usually because they applied to that position, or a sourcer explicitly thought they were relevant. Another option is to find candidates who applied to a sub-optimal position, and highlight those that are actually a good fit for the existing position, probably highlighting the fact that they did not explicitly apply. Another option is to search the entire database in the ATS for candidates who were rejected in the past, but could be a good fit for an open position. Interfaces could present this information when a user is reviewing a specific position, or could see other analytics like the top candidates who could be used to fill any open position.

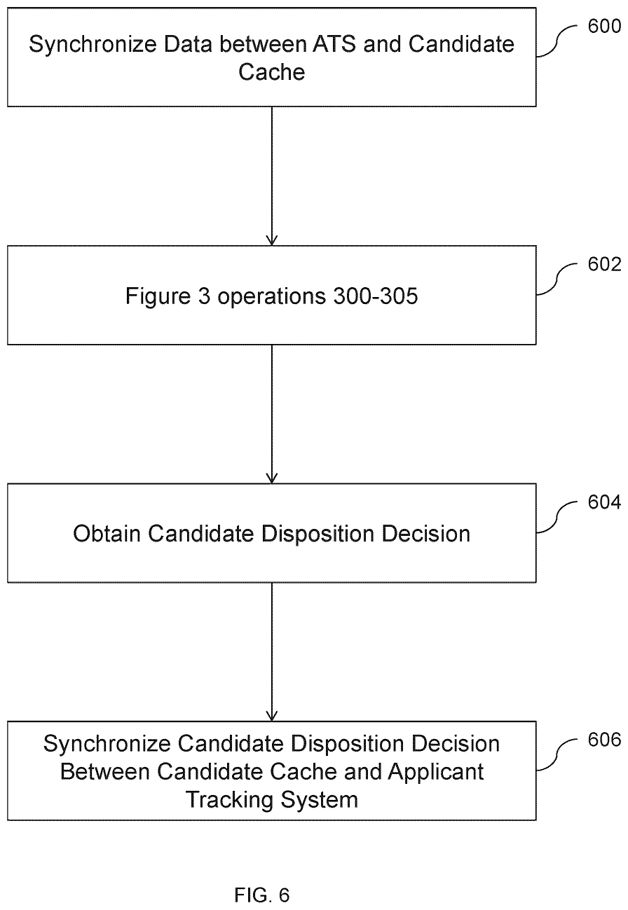

FIG. 6 is a flow diagram illustrating a method for applying machine learning system for the integration of a candidate filter and ranking system with an Applicant Tracking system in one embodiment of the present disclosure. At 600, data is synchronized via the system API and the ATS API. The data, specifically candidate data, from the ATS is cached for faster access, and mappings between the APIs are maintained. At 602, the same pipeline is used for ingesting data about new candidates and new evaluations, which are used to generate updated models, which in turn generate predictions.

At 604, we obtain a candidate disposition decision. This may be done implicitly through an explicit user review where thumbs down means reject and thumbs up means bring in for an interview, or more explicitly where a user can go to any set of users 3 stars and above out of 5 and select for them to be interviewed, and those 1 to 2 stars would get rejected. It could also not even involve a user's explicit evaluation, for instance allowing the user to filter all resumes predicted to be 3 stars or more, but never explicitly evaluated, and determined to be brought in for an interview. This information would be cached locally and synchronized later, or could be pushed immediately to the ATS. In one embodiment of the system, the process is performed in reverse, such that previous candidate disposition decisions, such as who was hired and fired in the past, are used to generate artificial judgments, which in turn can be used to train a model for candidates similar to those that were hired, or dissimilar to those that were rejected in the past.

At 606, if the data is cached, one such embodiment contemplates synchronizing the data and decision to the ATS. This might be triggering something in the ATS such as sending an email based on the decision, or simply marking the information in some other way that is easy for the user to interact with on the ATS side, for instance marking every candidate that should be rejected with a corresponding tag for that candidate and position.

An embodiment of the system highlights relevant candidates in the ATS that are not directly associated with the position. One example of such a use case is to highlight users who were rejected in the past, but are useful now. Another example is to highlight users who are a good fit for a specific position, despite being processed for a different position. Note that this system could work automatically, applying each position's models to all potential candidates, without requiring user intervention. It could involve other steps prior to evaluating all candidates, such as filtering candidates that are likely to be relevant before applying the predictive model.

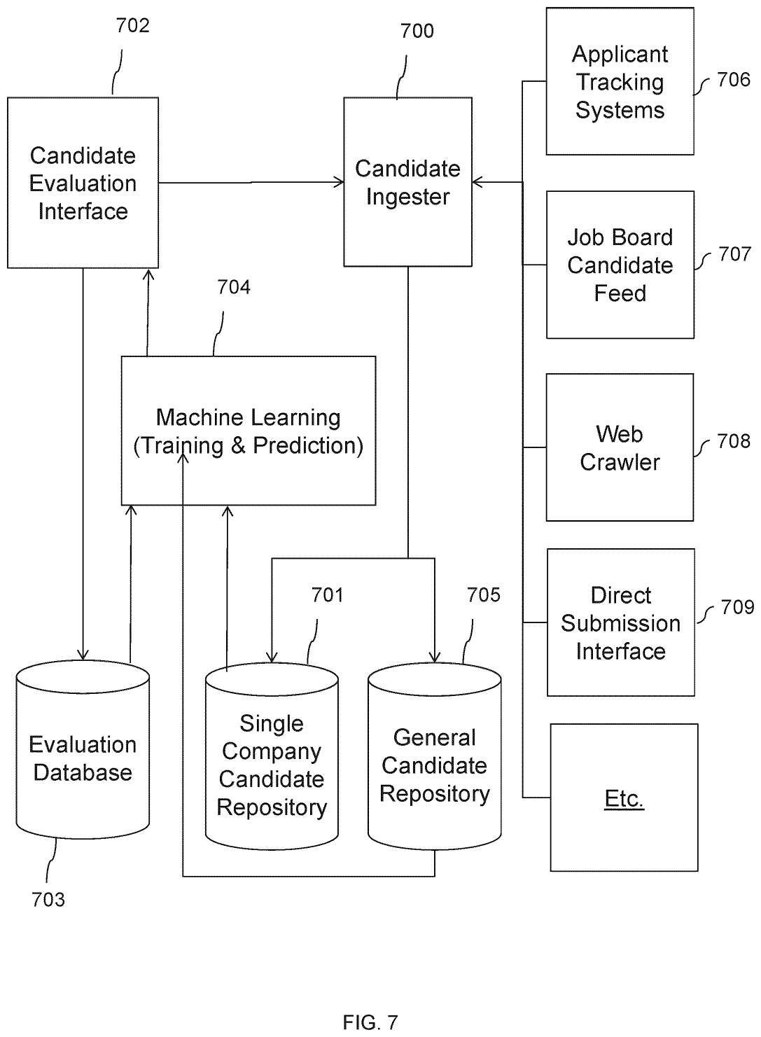

Once we have a ranking and filtering engine, we can go further than just syncing with an ATS to find places where users can gather resumes. FIG. 7 is a diagram illustrating the system components for such a system, whereby an intra-company sourcing system is coupled with a candidate filtering and ranking system.

In this process, the functionality of parts 700, 701, 702, and 703 correspond to the components 503, 504, 553, and 507, respectively. However, instead of pulling data from the Applicant Tracking System, a number of different mechanisms to source candidates are considered. The simplified interaction between the host system and the ATS is depicted between the Candidate Ingester 700, which may also synchronize data back into a third-party system, and the Applicant Tracking Systems 706. Job board candidate feed 707, web crawler 708 and direct submission interface 709 may be different machines connected to network 106 of FIG. 1.

One difference between this extension and the process described in FIG. 5, is the distinction between a Single Company Candidate Repository 701 and a General Candidate Repository 705. The Single Company Candidate Repository 701 uses datasets that are insulated from everyone else outside the company, while the General Candidate Repository 705 is a shared pool across all companies in the system The general candidate repository 705 may correspond to candidate data repository 182 of candidate data repository server 170 in FIG. 1. The system could integrate with a feed from one or many job board via APIs, or feeds like an RSS feed from Job Boards 707. One such instantiation is a job board where a user provides a resume, and possibly other criteria such as size of company, industry, or desired locations, etc., and the system scans all open positions using the disclosed filtering system to determine potentially good matches. The good matches are filtered or ranked with other criteria, allowing users to find candidates for which they are already a good match and know the companies would want to interview them In another instantiation, the job board uses the resume submission to a specific company in a way anonymous to the companies, but using their criteria, to tell candidates of other positions that they might want to apply to.

The system could integrate with a web-crawler 708. The web crawler searches the Internet, particularly at job boards that have resume repositories, and finds sources of candidates. Those candidates may not be presented in the form of the resume, but may need to be transformed into a something similar in format to a resume. The candidates could then be compared to open positions, and the best fit-candidates could be highlighted.

Note that the type of web-crawler does not need to be limited to a “Google” style web crawler where content is ingested through a backend server. This could include a browser plugin, which analyzes the current page for candidate-relevant metadata, and uses that to reflect the best positions a candidate is relevant for, and a score of relevancy. It could also automate some of the browsing process, whereby it automatically navigates to different pages, for instance candidates in a search result, to find the most promising candidates for respective positions. These promising candidates could then be automatically imported into the Single 700 or General 705 Candidate Repositories.

The system could also allow for users to submit their resumes and other candidate metadata like location or size of company interest, directly to the system 709 via a user interface such as a mobile or web interface. This allows the system to determine which candidates are relevant to which positions. This information can then be relayed back to the client, without the company knowing that the person is a good fit until they applied. Alternatively, the candidate could submit their information and the system could surface the candidate information just to the positions that are particularly relevant. In one embodiment, the applying candidate are anonymized, requiring companies to compensate the host system in some way, for instance paying per candidate, to see obscured information. The information the system relays back may not necessarily be directly to an interface; it could be fed back into the third-party ecosystem, for instance for a job-board to surface on their own website.

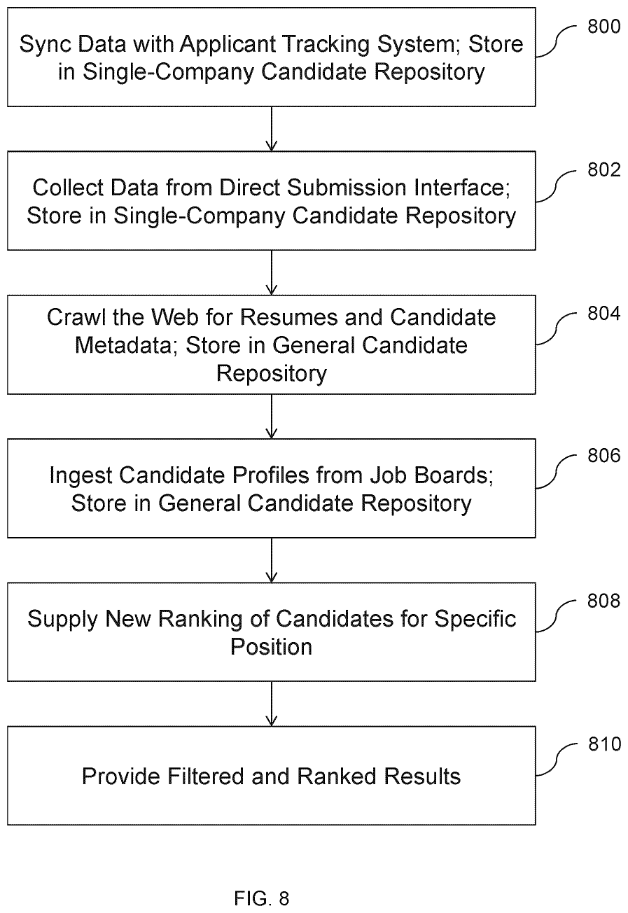

FIG. 8 is a flow diagram illustrating a method for an intra-company sourcing system coupled with a candidate filtering and ranking system in one embodiment of the present disclosure. At 800, in one embodiment, the system synchronizes data with the applicant tracking system, and stores that in the single-company candidate repository. At 802, in one embodiment, the system collects data from the direct submission interface, and stores it in the correct repository depending on the setup of the user. In one such example, the user submits their Candidate Information including information such as their resume or preferred location, to search for relevant positions they could apply to. In this case, it would be added to the General Candidate Repository. If the user applied to a specific position at a company, that data should be scoped to the company, and thus would be stored in the Single-Company Candidate Repository.

At 804, in one embodiment, the system crawls the web for resumes and other candidate metadata, and stores it in the general candidate repository for all candidates to access. At 806, in one embodiment, the system ingests candidate information from job boards, and sends them to the general candidate repository.

At 808, the system takes relevant data, which may require additional filtering, from the General and Single-Company Candidate Repositories to the Candidate Training and Prediction System At 810, the system filters and ranks the candidates for presentation in a user interface.

An embodiment of the present invention relates to a computer storage product with a computer readable storage medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code, such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using JAVA®, C++, or other object-oriented programming language and development tools. Another embodiment of the invention may be implemented in hardwired circuitry in place of, or in combination with, machine-executable software instructions.

The foregoing description, for purposes of explanation, used specific nomenclature to provide a thorough understanding of the invention. However, it will be apparent to one skilled in the art that specific details are not required in order to practice the invention. Thus, the foregoing descriptions of specific embodiments of the invention are presented for purposes of illustration and description. They are not intended to be exhaustive or to limit the invention to the precise forms disclosed; obviously, many modifications and variations are possible in view of the above teachings. The embodiments were chosen and described in order to best explain the principles of the invention and its practical applications; they thereby enable others skilled in the art to best utilize the invention and various embodiments with various modifications as are suited to the particular use contemplated. It is intended that the following claims and their equivalents define the scope of the invention.

What is claimed is:

1. A computer-implemented method, comprising:
obtaining filter criteria;
applying the filter criteria to job candidate data about job candidates of a candidate data repository to obtain filtered job candidate search results;
training a model from the job candidate data from the candidate data repository;
storing the model in a machine learning models database;
executing the model with a machine learning system having the filtered job candidate search results as an input to the machine learning system;
processing the filtered job candidate search results, after applying the filter criteria to the job candidate data, using the machine learning system to rank at least a portion of the filtered job candidate search results into a ranked subset of the filtered job candidate search results;
applying supervised training to the model based on example job candidate records from the least a portion of the filtered job candidate search results;
revising the model based on the supervised training to form a revised model; and
producing scores for job candidates of the filtered job candidate search results based on the revised model.

2. The computer-implemented method of claim 1, further comprising ordering candidates based on effectiveness in improving predictions.

3. The computer-implemented method of claim 1, further comprising supplying prompts to a user to obtain equating synonyms as a single feature to improve machine learning accuracy.

4. The computer-implemented method of claim 1, further comprising receiving a user selection of an initial model to bootstrap predictions for a position.

5. The computer-implemented method of claim 1, further comprising masking job candidate information biased toward a demographic.

6. The computer-implemented method of claim 1, further comprising parsing resumes with domain-specific features prior to sending the resumes to the model.

7. The computer-implemented method of claim 1, further comprising generating synthetic resumes from parsed resumes.

8. The computer-implemented method of claim 1, further comprising crawling a network from a browser plugin for job candidates and producing the scores for the job candidates.

9. The computer-implemented method of claim 1, further comprising generating a single predicted rating for an unevaluated candidate from multiple user evaluations of a subset of candidates.

10. The computer-implemented method of claim 9, further comprising generating reports of a maximum disagreement of users about the same candidates.

11. The computer-implemented method of claim 1, further comprising ingesting data submitted to job boards and providing feedback to the job boards and applying candidates about the quality of proposed candidate-position pairings.

12. A computer-implemented method, comprising:
collecting hyper-parameters specifying values to minimize a machine learning error metric or maximize a machine learning accuracy metric;
revising machine learning models based upon the hyper-parameters to form current machine learning models for specific positions at specific companies;
filtering job candidate data using a search engine to provide filtered job candidate data;
processing the filtered job candidate data, filtered using the search engine, with the current machine learning models to produce scores for job candidates based on fitness for a specific position at a specific company, wherein the current machine learning models are trained using supervised training based on evaluation data related to an evaluated set of candidates from the filtered job candidate data, wherein the evaluation data comprises user evaluation of the candidates in the evaluation set; and
supplying the scores for the job candidates.

13. The method of claim 12, further comprising using unsupervised machine learning to identify job candidates in clusters similar to a processed cluster.

14. The method of claim 12, further comprising supplying prompts to a user to obtain equating synonyms as a single feature to improve the machine learning accuracy metric.

15. The method of claim 12, further comprising collecting different weights for keywords.

16. The method of claim 12, further comprising generating synthetic resumes from parsed resumes.

17. The method of claim 12, further comprising identifying candidates for positions the candidates did not apply for.

18. The computer-implemented method of claim 12, further comprising masking job candidate information biased toward a demographic.

19. The method of claim 12, further comprising crawling a network for job candidates.

20. The method of claim 19, further comprising ingesting data submitted to job boards and providing feedback to the job boards and applying candidates about the quality of proposed candidate-position pairings.
